(19) United States
(12) Patent Application Publication
(10) Pub. No.: US 2026/0214756 A1
(43) Pub. Date: Jul. 23, 2026

(54) LIQUID HEATER MODULE

(71) Applicant: LLOYDS IP HOLDINGS, LLC, Pomona, CA (US)

(72) Inventor: Casey Loyd, Pomona, CA (US)

(73) Assignee: LLOYDS IP HOLDINGS, LLC, Pomona, CA (US)

(21) Appl. No.: 19/393,525

(22) Filed: Nov. 18, 2025

Related U.S. Application Data
(60) Provisional application No. 63/746,896, filed on Jan. 17, 2025.

(51) Int. Cl. H05B 3/50; H05B 3/10

(52) U.S. Cl. CPC H05B 3/50; H05B 3/10; H05B 2203/017; H05B 2203/021

(57) ABSTRACT

A liquid heater module comprising a metallic tube and a heating element that is coiled about and brazed onto the outside of the tube, thereby providing an essentially unobstructed passage for liquid being heated thereby.

### CROSS-REFERENCE TO RELATED APPLICATION

This application claims the benefit of U.S. Provisional Patent Application No. 63/746,896, filed on Jan. 17, 2025, which is incorporated herein by reference.

### FIELD OF THE INVENTION

The present invention relates to an electric liquid heater module. More specifically, the present invention relates to such a module having a heating element that is not exposed to the liquid.

### BACKGROUND INFORMATION

Water heaters, both gas and electric, are commonplace in the market today. Electric water heaters typically have an electrically conductive heating coil submerged in the liquid within a tank. Problems with this arrangement involve contamination and/or erosion of the coil.

Thus there is a need for a liquid heater that overcomes at least some of the disadvantages of those presently available.

### SUMMARY OF THE INVENTION

The liquid heater module of the present invention meets the above needs by isolating the heating element from the liquid while providing efficient conduction of heat to the liquid. In one aspect of the present invention, a metallic tube member for passing a liquid such as water has an elongate heating element coiled around the tube member, the heating element being brazed onto the tube member.

In another aspect of the present invention, there is a method for producing the heater module including the steps of wraping a medial portion of the heating element under tension about the metallic tube member, and brazing the heating element onto the tube member.

The present invention meets this need by providing an essentially unobstructed tubular passage for the liquid with an external heating element that is thermally close-coupled to the passage.

### BRIEF DESCRIPTION OF THE DRAWINGS

These and other features, aspects, and advantages of the present invention will become better understood with reference to the following description, appended claims, and accompanying drawings, where:

FIG. 1 is a side view of a liquid heater module according to the present invention;

FIG. 2 is a sectional view of the heater module of FIG. 1 on line 2-2 thereof, a portion of the view being rotated into the plane of the figure;

FIG. 3 is a detail view of the heater module of FIG. 1 within region 3 thereof;

### DETAILED DESCRIPTION

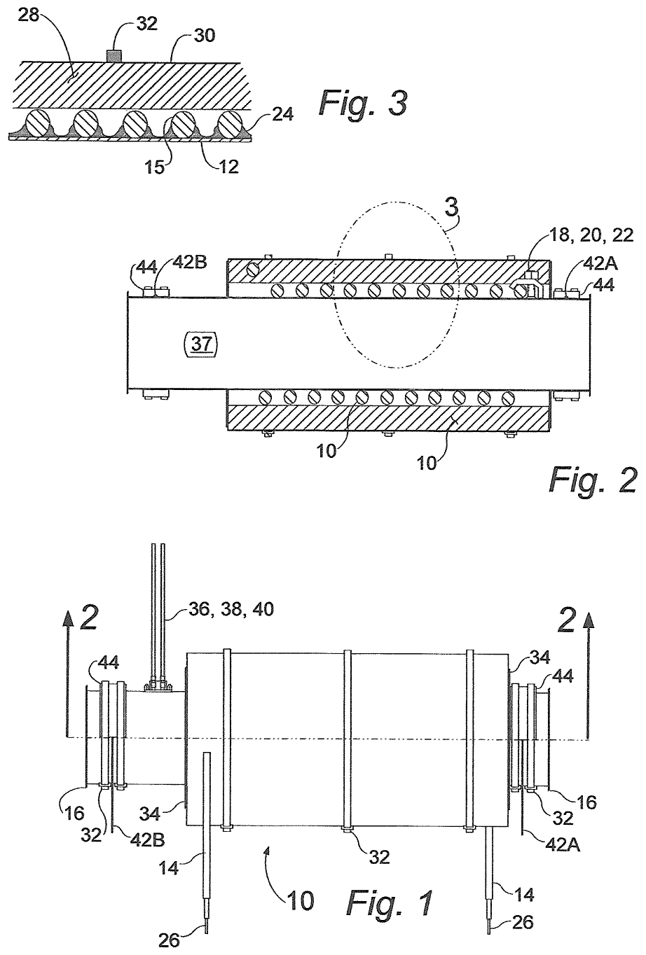

The present invention is directed to an electric liquid heater module that has its heating element isolated from the liquid. With reference to FIGS. 1-3 of the drawings, a heater module 10 includes a main metallic tube 12, an electrically conductive heating element 14 on the outside of the tube and thermally coupled therewith. The main metallic tube 12 is preferably made of 316 stainless steel for enhanced corrosion resistance, and can have respective flanges 16 formed at opposite ends thereof for connection to additional piping in a conventional manner.

The heating element 14 is of conventional construction, having an elongate outer metallic sheath of stainless steel, typically having an outside diameter of approximately 5/16 inch and an inner 14 awg (2.5 mm) copper wire that is electrically isolated from the metallic sheath by suitable insulation such as magnesium oxide powder. Heating elements of this type are available, for example, from Cynebar, Unit 11/6, Whitelaw Place, Richlands, which is near Brisbane, Australia.

The heater element 14 can typically have a power rating anywhere from 1 kW to 7 kW, although in the spa industry 5.5 kW is most common and those of 4 kW are also used.

According to the present invention, the heating element 14 is coiled about the main metallic tube 12 in helical form, opposite ends of the helical portion, designated 15, preferably being secured by respective clamp members 18, each clamp member 18 being anchored on a threaded stud 20 by a clamp nut 22, the stud 20 being welded onto the main metallic tube 12. The thermal coupling is enhanced by a suitable brazing material 24 such as nickel. Opposite free ends of the heating element 14 are provided with respective ring terminals 26 for connection to suitable control circuitry as further described below.

Preferably the helical portion 15 of the heating element 14 is covered by a suitable thermal insulative material 28 such as fiberglass, which is wrapped in aluminum foil 30 and secured by a plurality of zip ties 32. Preferably, respective high-temperature thermally insulative disks 34 are installed at opposite ends of the insulative material 28, which can be formed of mica sheet material and slit for forming past the flanges 16 of the metallic tube 12.

Preferably the heating module 10 is provided with a high limit sensor switch 36 that is mounted on the main metallic tube 12 near one of the insulative disks 34 for cutting electrical power to the heating element 14 in case of over-heating, and while the liquid flow can be in either direction the sensor switch 36 is preferably downstream of the nearby insulative disk 34. A suitable sensor switch is available from Zettler Temperature Controls of Lake San Marcos, CA, model KSD301A. Mounting of the sensor switch 36 is facilitated by locally flattening of the main metallic tube 12 and anchoring the sensor switch 36 with suitable threaded studs 38 that are welded to the metallic tube 12 and provided with clamp nuts 40 the flatted area is indicated at 37 in FIG. 2.

Additionally, the heating module 10 is preferably provided with at least one temperature sensor 42 to be used in controlling the heating element 14. As shown in FIG. 1, a first temperature sensor 42A is located close to one of the insulative disks 34 near one end of the main metallic tube 12, a second temperature sensor 42B being located near the opposite end of the metallic tube 12. Each temperature sensor can be mounted to the outside of the main metallic tube 12 under a flexible clamp pad 44 that is secured by counterparts of the zip ties 32.

The heating module 10 can be connected to a thermostatic controller.

A method for producing the heater module 10 includes the steps of coiling the heating element 14 about the main metallic tube 12, brazing the heating element onto the tube, and covering the coiled portion of the heating element with a suitable insulating material.

1. A liquid heater module comprising:
a) a main metallic tube for passage of the liquid; and
b) an electrically conductive heating element comprising a tubular outer metallic sheath, an inner electrically conductive wire, and an insulating material surrounding the wire, the heating element being externally coiled around the tube and closely thermally coupled therewith by the outer metallic sheath being brazed onto the main metallic tube, so that the electrically conductive wire is electrically isolated from the main metallic tube.

2. The liquid heater module of claim 1, wherein the metallic tube is formed of stainless steel.

3. The liquid heater module of claim 2 wherein the stainless steel is alloy 316.

4. The liquid heater module of claim 1 wherein the outer metallic sheath comprises stainless steel and the insulative material comprises magnesium oxide.

5. The liquid heater module of claim 1 wherein the brazing material comprises nickel.

6. The liquid heater module of claim 1, further comprising a temperature sensor supported by the metallic tube.

7. The liquid heater module of claim 6, wherein the temperature sensor is clamped onto the metallic tube.

8. The liquid heater module of claim 6 wherein the temperature sensor is located downstream of the heating element.

9. A method for forming the liquid heater module of claim 1, comprising the steps of:
a) providing a main metallic tube for passage of the liquid;
b) providing an electrically conductive heating element comprising a tubular outer metallic sheath, an inner electrically conductive wire, and an insulating material surrounding the wire;
c) winding the heating element under tension about the main metallic tube; and
d) brazing the heating element onto the metallic tube.
